(19) United States
(12) Patent Application Publication
(10) Pub. No.: US 2011/0106530 A1
(43) Pub. Date: May 5, 2011

(54) APPARATUS AND METHOD FOR IMPROVING VOICE QUALITY IN PORTABLE TERMINAL

(75) Inventor: Tae-Seon KIM, Seoul (KR)

(73) Assignee: SAMSUNG ELECTRONICS CO. LTD., Suwon-si (KR)

(21) Appl. No.: 12/908,433

(22) Filed: Oct. 20, 2010

(30) Foreign Application Priority Data
Oct. 29, 2009 (KR) 10-2009-0103620

(51) Int. Cl. G10L 11/04

(52) U.S. Cl. 704/206; 704/E11.001

(57) ABSTRACT

An apparatus and method for improving a sound quality of a portable terminal are provided. Particularly, an apparatus and method for tuning to a voice quality that a user desires using the portable terminal, in case where the user determines an abnormal sound quality, are provided. The apparatus includes a sound quality improving unit for selecting a Digital Signal Processing (DSP) filter value corresponding to a voice quality that a user desires among a plurality of DSP filters for controlling the voice quality according to a user's voice quality.

### PRIORITY

This application claims the benefit under 35 U.S.C. §119(a) of a Korean patent application filed on Oct. 29, 2009 in the Korean Intellectual Property Office and assigned Serial No. 10-2009-0103620, the entire disclosure of which is hereby incorporated by reference.

### BACKGROUND OF THE INVENTION

1. Field of the Invention

The present invention relates to an apparatus and method for improving a sound quality of a portable terminal. More particularly, the present invention relates to an apparatus and method for tuning to a voice quality that a user desires, in case where the user determines an abnormal sound quality, by a predefined motion using the portable terminal.

2. Description of the Related Art

With the recent rapid development of portable terminals, more particularly, the portable terminals enabling a wireless voice call and information exchange become daily necessities. When the portable terminals were first introduced to the public, it was simply recognized that they are portable and can make a wireless call. However, with their technological development and the introduction of the wireless Internet, the portable terminals have significantly increased in scope, such as playing games, remote control using local area communication, and image capture by an installed digital camera as well as the purpose of simple telephony, schedule management, and the like and thus, have satisfied a user's desire.

The portable terminals are intended to provide more supplementary functions but, for the sake of their inherent wireless call functions, they also need to provide improved voice qualities to users.

The portable terminals are manufactured to output a fixed voice quality for every model upon release (i.e., to output a fixed voice quality using a filter value depending on a call mode).

To output the fixed voice quality as stated above is to set a fixed voice quality on the basis of an average user's hearing, which can provide a sound quality clear to some degree to a young user or a user having normal hearing and a user located in a place where no external noise exists.

However, there is a problem where users cannot distinctly recognize a called party's voice, in case where a user having poor hearing or a user located in an area of a serious ambient noise performs a call connection using the portable terminal. More particularly, it is difficult to recognize the ambient noise and to output a fixed voice quality according to the ambient noise.

Therefore, a need exists for a system and method for recognizing an ambient noise and changing a voice quality into a voice quality of a high frequency band.

### SUMMARY OF THE INVENTION

An aspect of the present invention is to address at least the above-mentioned problems and/or disadvantages and to provide at least the advantages below. Accordingly, an aspect of the present invention is to provide an apparatus and method for improving the voice quality of a portable terminal.

Another aspect of the present invention is to provide an apparatus and method for improving a voice quality of a portable terminal using a predefined motion.

A further aspect of the present invention is to provide an apparatus and method for changing a value of a transmitting/receiving filter depending on the noise level near a user operating a portable terminal and improving a voice quality in the portable terminal.

In accordance with an aspect of the present invention, an apparatus for improving a voice quality in a portable terminal is provided. The apparatus includes a sound quality improving unit for changing a Digital Signal Processing (DSP) filter value for controlling a voice quality according to a user's voice quality.

In accordance with another aspect of the present invention, a method for improving a voice quality in a portable terminal is provided. The method includes changing a Digital Signal Processing (DSP) filter value for controlling a voice quality according to a user's voice quality.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a construction of a portable terminal for improving a voice quality according to an exemplary embodiment of the present invention;

FIG. 2 is a flow diagram illustrating a process for a user to request a voice quality improvement in a portable terminal according to an exemplary embodiment of the present invention;

FIG. 3 is a flow diagram illustrating a process of improving a voice quality in a portable terminal according to an exemplary embodiment of the present invention;

FIG. 4A is a graph illustrating a filter applied to a portable terminal according to an exemplary embodiment of the present invention;

FIG. 4B is a graph illustrating a Low Pass Filter (LPF) applied to a portable terminal according to an exemplary embodiment of the present invention; and

FIG. 4C is a graph illustrating a High Pass Filter (HPF) applied to a portable terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus and method for changing a filter value, which is defined depending on the noise level near a user operating a portable terminal, and for providing a voice quality that the user desires in the portable terminal. In this case, the filter value defined depending on the noise level is a filter whose gain value of a high frequency band or a low frequency band is differently set to pass the high frequency band or the low frequency band. The portable terminal stores a plurality of filters defined depending on the noise level.

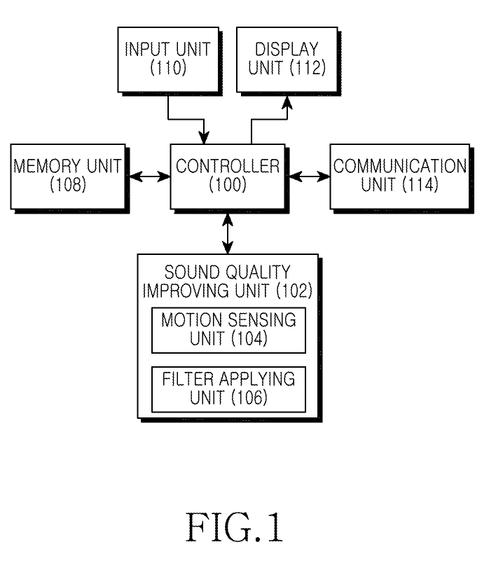

FIGS. 1 through 4C, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 1 is a block diagram illustrating a construction of a portable terminal for improving a voice quality according to an exemplary embodiment of the present invention.

Referring to FIG. 1, the portable terminal can include a controller 100, a sound quality improving unit 102, a memory unit 108, an input unit 110, a display unit 112, and a communication unit 114. The sound quality improving unit 102 may include a motion sensing unit 104 and a filter applying unit 106. The portable terminal may be a mobile terminal enabling a wireless voice call and information exchange, and may include additional units that are not illustrated here merely for the sake of clarity. Similarly, the functionality of two or more of the above units may be integrated into a single component.

The controller 100 of the portable terminal controls a general operation of the portable terminal. For example, the controller 100 processes and controls voice call and data communication. In addition to an overall function, according to an exemplary embodiment of the present invention, the controller 100 processes and provides a function for enabling a user to directly tune to a desired voice quality using a plurality of Digital Signal Processing (DSP) filters for controlling a voice quality.

That is, in case where a voice quality outputted is a high-frequency sound quality, the controller 100 processes and changes the outputted high-frequency sound quality into a low-frequency sound quality according to a user's request. In contrast, in case where the voice quality is a low-frequency sound quality, the controller 100 processes and changes the outputted low-frequency sound quality into a high-frequency sound quality. At this time, the controller 100 can process and control the sound quality improving unit 102 to improve a voice quality.

To provide a voice quality that a user desires under control of the controller 100, the sound quality improving unit 102 changes an outputted low-frequency voice quality into a high-frequency voice quality, and changes a high-frequency voice quality into a low-frequency voice quality.

At this time, the sound quality improving unit 102 determines a specific motion of the portable terminal and changes a sound quality corresponding to the determined motion.

The motion sensing unit 104 of the sound quality improving unit 102 includes a sensor capable of detecting the user's motion. By enabling the sensor, the motion sensing unit 104 collects detecting information used for judging a motion of the portable terminal. Accordingly, the sound quality improving unit 102 determines the motion of the portable terminal using the detecting information collected by the motion sensing unit 104.

The filter applying unit 106 of the sound quality improving unit 102 changes a currently set filter into a filter associated with a motion of the portable terminal, changes a voice quality that is output into a voice quality that a user desires, and provides the changed voice quality.

That is, the filter applying unit 106 stores a plurality of DSP filter values whose gain values are different from each other depending on a frequency band, according to an exemplary embodiment of the present invention, and changes a sound quality using the filter value associated with the motion of the portable terminal.

The plurality of DSP filter values represent filters whose gain values of a high frequency band and a low frequency band are differently set to pass the high frequency band and the low frequency band.

The memory unit 108 may include, for example, any or all of a Read Only Memory (ROM), a Random Access Memory (RAM), a flash ROM, and the like. The ROM stores a microcode (i.e., code) of a program for processing and control of the controller 100 and the sound quality improving unit 102, and a variety of kinds of reference data.

The RAM serves a working memory of the controller 100 and stores temporary data occurring during execution of various programs. The flash ROM may store a various updateable depository data such as a phone book, an outgoing message, an incoming message, and the like.

The input unit 110 includes numeral key buttons ‘0’ to ‘9’, a menu button, a cancel button, an OK button, a talk button, an end button, an Internet button, navigation key buttons, and a plurality of function keys such as a character input key. The input unit 110 provides key input data (e.g., an input for selection of contents intended for reproduction) corresponding to a key pressed by a user to the controller 100.

The display unit 112 displays state information generated during operation of the portable terminal, limited number of characters, a large amount of moving pictures and still pictures, and the like. The display unit 112 may be a color Liquid Crystal Display (LCD), an Active Mode Organic Light Emitting Diode (AMOLED), and the like. The display unit 112 may have a touch input device. When the display unit 112 having the touch input device is applied to a touch input type portable terminal, the display unit 112 may serve as an input unit.

The communication unit 114 performs a function of transmitting/receiving and processing a radio signal of data input/output through an antenna (not illustrated). For example, in a transmission mode, the communication unit 114 processes original data through channel coding and spreading, converts the original data into a Radio Frequency (RF) signal, and transmits the RF signal. In a reception mode, the communication unit 114 converts a received RF signal into a baseband signal, processes the baseband signal through de-spreading and channel decoding, and restores the signal to original data.

A role of the sound quality improving unit 102 may be implemented by the controller 100 of the portable terminal. However, these are separately constructed and shown in the present invention as an exemplary construction for description convenience only, and are not for limiting the scope of the present invention. That is, it would be understood by those skilled in the art that various modifications of construction can be made within the scope of the present invention. For example, all of the functions of the sound quality improving unit 102 may be processed by the controller 100.

An exemplary apparatus for changing a filter value, which is defined depending on the noise level near a user operating a portable terminal, and for providing a voice quality that a user desires in a portable terminal has been described above. An exemplary method for changing a defined filter value and for providing a voice quality that a user desires, using the above-described apparatus according to an exemplary embodiment of the present invention, is described below.

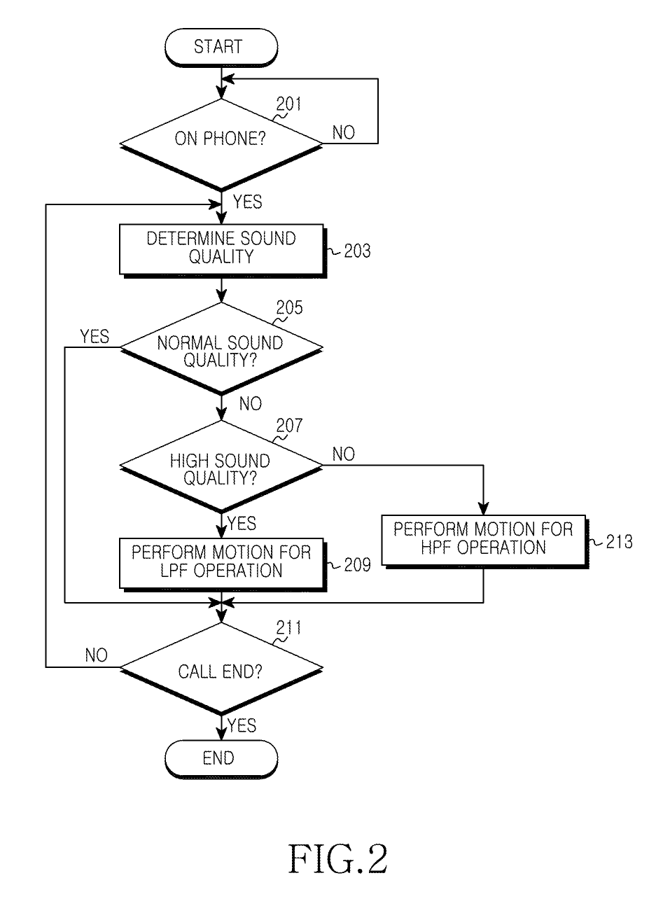

FIG. 2 is a flow diagram illustrating a process for a user to request a voice quality improvement in a portable terminal according to an exemplary embodiment of the present invention.

Referring to FIG. 2, the user of the portable terminal determines whether he/she is on the phone with a called user, using the portable terminal in step 201.

In step 201, if it is determined that the user of the portable terminal is not on the phone with the called user, the user of the portable terminal re-performs the process of step 201.

In contrast, if it is determined in step 201 that the user of the portable terminal is on the phone with the called user, the user of the portable terminal determines a voice quality for the called user who is currently on the phone in step 203.

Step 203 is a process for determining if the voice quality recognized by the user is in a state of making a normal call impossible because of a high frequency band or a low frequency band.

The result of step 203 is then determined by the user of the portable terminal in step 205.

In step 205, if it is determined that the voice quality for the called user is a normal sound quality, the user of the portable terminal determines whether a call connection ends in step 211. If it is determined in step 211 that the call connection is not ended, the user of the portable terminal re-performs the process of step 203. That is, the portable terminal performs the above operation until the end of the call connection with the called user.

In contrast, if it is determined in step 205 that the voice quality for the called user is an abnormal sound quality, the user of the portable terminal determines if the sound quality of step 203 is a high sound quality or a low sound quality in step 207.

In step 207, if it is determined that the voice quality for the called user is a high sound quality, the user of the portable terminal proceeds to step 209 and performs a motion for Low Pass Filter (LPF) operation.

In contrast, if it is determined in step 207 that the voice quality for the called user is a low sound quality, the user of the portable terminal performs a motion for High Pass Filter (HPF) operation in step 213.

The motion for the low pass or high pass filter operation can be either a preset motion or an easy motion directly set by a user.

After performing the motion for voice quality improvement in step 209 or 213, the user of the portable terminal determines if the call connection with the called user ends in step 211.

If it is determined in step 211 that the call connection does not end, the user of the portable terminal returns back to step 203.

That is, the user of the portable terminal can set a voice quality by a specific motion in a call connection state and, through the above method, can improve a voice quality.

In contrast, if it is determined in step 211 that the call connection ends, the user of the portable terminal terminates the procedure according to the exemplary embodiment of the present invention.

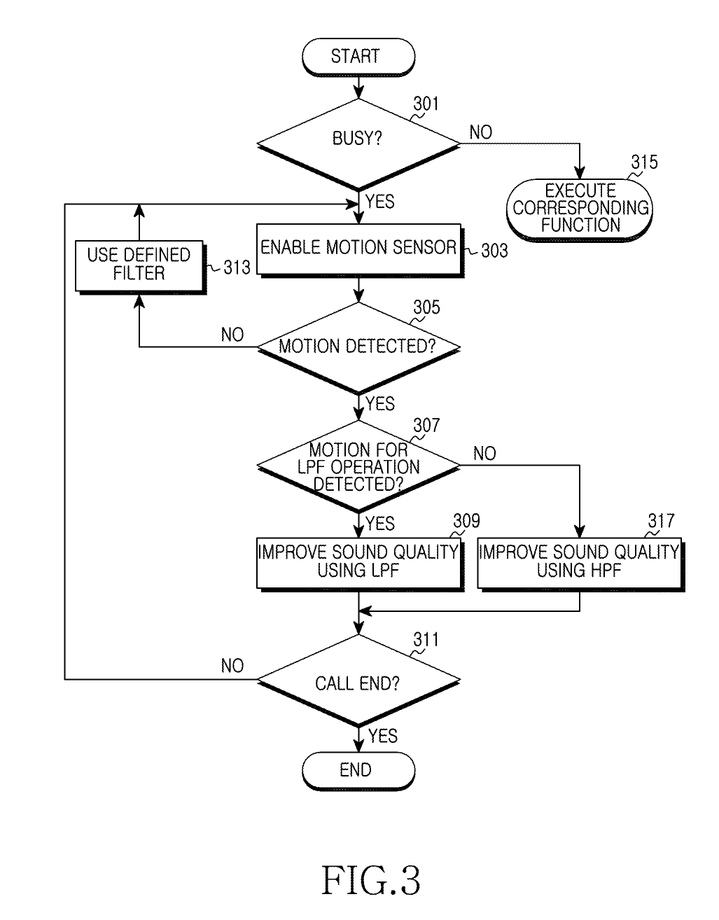

FIG. 3 is a flow diagram illustrating a process of improving a voice quality in a portable terminal according to an exemplary embodiment of the present invention.

Referring to FIG. 3, the portable terminal determines if it is busy with a called portable terminal in step 301.

If it is determined in step 301 that the portable terminal is not busy, the portable terminal performs a corresponding function (e.g., an idle mode) in step 315.

In contrast, if it is determined in step 301 that the portable terminal is busy, the portable terminal enables a motion sensor capable of detecting a user's motion in step 303. Here, the motion sensor is a sensor capable of determining the user's motion, and includes a gyro sensor, an angle sensor, and the like.

After enabling the motion sensor for detecting the user's motion in step 303, the portable terminal determines if it detects a motion of a user holding the portable terminal in step 305.

In step 305, if the motion of the user is not detected, the portable terminal determines that a voice quality recognized by the user is normal. After that, the portable terminal processes and outputs a call sound using a defined filter in step 313. Here, the defined filter, which is a filter defined as a default in a portable terminal, refers to a filter value capable of providing a call sound that can be satisfied by most users.

In contrast, if the motion of the user is detected in step 305, the portable terminal determines the type of user motion in step 307.

Here, the type of user motion is a motion of selecting the type of filter for voice quality improvement. For example, the type of user motion may be a motion of the user of the portable terminal for requesting to use an LPF for a high-frequency sound quality (i.e., a motion of shaking the portable terminal to the left) and a motion of the user for requesting to use an HPF for a low-frequency sound quality (i.e., a motion of shaking the portable terminal to the right).

In step 307, if a motion for an LPF operation is detected, the portable terminal improves a voice quality using the LPF in step 309.

In contrast, if a motion for an HPF operation is detected in step 307, the portable terminal improves a voice quality using the HPF in step 317.

After improving the voice quality in step 309 or 317, the portable terminal determines if the previous call connection ends in step 311.

In step 311, if it is determined that the previous call connection does not end, the portable terminal returns to step 303.

That is, the portable terminal detects a motion of a user until the end of the previous call connection and changes a filter for a call sound corresponding to the detected motion.

In contrast, if it is determined in step 311 that the previous call connection ends, the portable terminal terminates the procedure according to the exemplary embodiment of the present invention.

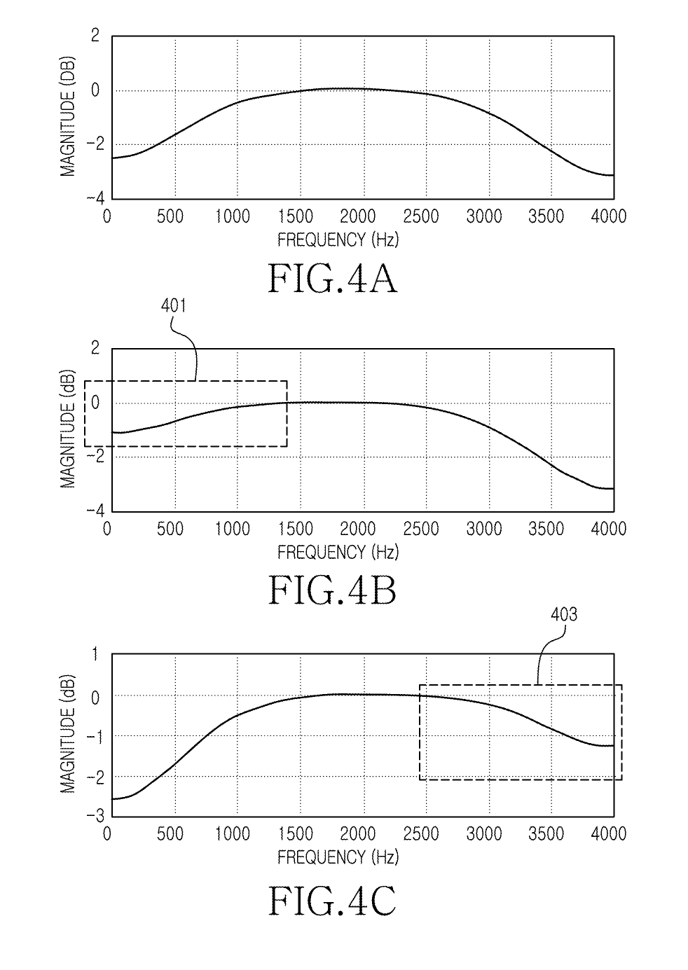

FIGS. 4A-4C are graphs illustrating filters for improving a voice quality in a portable terminal according to an exemplary embodiment of the present invention.

FIG. 4A is a graph illustrating a filter applied to a portable terminal.

Referring to FIG. 4A, the filter applied to the portable terminal is a fixed filter that is set on the basis of an average user's hearing.

The portable terminal using the filter of FIG. 4A may provide a sound quality clearness of any degree to a young user or a user having normal hearing and a user located in a place where no external noise exists.

However, there is a problem where users cannot clearly recognize a called party's voice, in case where a user of bad hearing or a user located in an area where ambient noise exists performs a call connection using the portable terminal.

As illustrated in FIG. 4A, it can be appreciated that the filter applied to the portable terminal has a low gain value before and after a frequency band of about 1500 Hz to 2500 Hz.

FIG. 4B is a graph illustrating an LPF applied to a portable terminal according to an exemplary embodiment of the present invention.

Referring to FIG. 4B, the LPF applied to the portable terminal is a filter for improving a sound quality of a low frequency band of the portable terminal to a constant sound quality.

In case where a user of the portable terminal determines the sound quality of the low frequency band, the portable terminal improves a voice quality using the LPF.

At this time, the user requests the use of the LPF through a specific motion according to an exemplary embodiment of the present invention.

In a comparison between the LPF of FIG. 4B and the filter of FIG. 4A having the low gain value before and after the frequency band of about 1500 Hz to 2500 Hz, the difference is given as follows.

As described above, the filter of FIG. 4A has the low gain value before and after the frequency band of about 1500 Hz to 2500 Hz.

In case where the filter of FIG. 4A is used, the user of the portable terminal cannot clearly receive the contents of a call of a low frequency band. Thus, the user can clearly determine a called party's voice of the low frequency band, by using the LPF of FIG. 4B increasing (401) a gain of the low frequency band of about 0 Hz to 1000 Hz according to an exemplary embodiment of the present invention. The LPF can be used for changing a voice quality of a high frequency band inducing ambient noise into a voice quality of a low frequency band.

FIG. 4C is a graph illustrating an HPF applied to a portable terminal according to an exemplary embodiment of the present invention.

Referring to FIG. 4C, the HPF applied to the portable terminal is a filter for improving a sound quality of a high frequency band of the portable terminal to a constant sound quality.

In case where a user of the portable terminal determines the sound quality of the high frequency band, the portable terminal improves a voice quality using the HPF.

At this time, the user requests the use of the HPF through a specific motion according to an exemplary embodiment of the present invention.

In a comparison between the HPF of FIG. 4C applied to the portable terminal and the filter of FIG. 4A having the low gain value before and after the frequency band of about 1500 Hz to 2500 Hz, the difference is given as follows.

As described above, the filter of FIG. 4A has the low gain value before and after the frequency band of about 1500 Hz to 2500 Hz.

In case where the filter of FIG. 4A is used, the user of the portable terminal cannot clearly receive the contents of a call of a high frequency band. Thus, the user can clearly determine a called party's voice of the high frequency band, by using the HPF of FIG. 4C increasing (403) a gain of the high frequency band of about 2500 Hz to 4000 Hz according to an exemplary embodiment of the present invention. The HPF of FIG. 4C can be used for changing a voice quality of a low frequency band of a called party who calls in a low voice at a place such as a library, into a voice quality of a high frequency band.

That is, by using a plurality of filters, a portable terminal according to an exemplary embodiment of the present invention changes a voice quality of a low frequency band received at a quiet place into a voice quality of a high frequency band, and changes a voice quality of a high frequency band received at a place where ambient noise exists into a voice quality of a low frequency band. At this time, the portable terminal can change a transmission/reception sound quality by using a corresponding filter depending on a predefined user's motion.

The above description is made for a method for tuning to a voice quality that a user desires, using a predefined filter value dependent on a motion of a portable terminal according to an exemplary embodiment of the present invention. Unlike this, in another exemplary embodiment of the present invention, in case where a specific motion is detected, the portable terminal can change a gain value of a high frequency band or low frequency band as much as a constant magnitude and change a sound quality of transmission/reception sound. At this time, the portable terminal can use one filter in place of a plurality of filters.

As one example, the present invention can also improve a voice quality by, whenever detecting a motion for high pass, increasing a gain corresponding to a high frequency band as much as a constant magnitude and, whenever detecting a motion for low pass, increasing a gain corresponding to a low frequency band as much as a constant magnitude.

As described above, the present invention relates to an apparatus and method for improving a voice quality of a portable terminal depending on the noise level near a user operating the portable terminal. In an exemplary embodiment of the present invention, a user can directly set a desired sound quality and improve a voice quality by changing a transmitting/receiving filter corresponding to a characteristic of a sound quality that a user desires, using a predefined motion.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for improving a voice quality in a portable terminal, the apparatus comprising:
a sound quality improving unit for changing a Digital Signal Processing (DSP) filter value; and
a controller for controlling a voice quality according to a user's voice quality based on the changed DSP filter value.

2. The apparatus of claim 1, wherein the sound quality improving unit changes the DSP filter value by detecting a user's motion, determining a filter value corresponding to the user's motion, and changing a transmission/reception sound quality using the determined filter value.

3. The apparatus of claim 2, wherein, in case where it is determined that the portable terminal is busy, the sound quality improving unit enables a sensor capable of detecting a motion, and determines a motion of the portable terminal using the detecting information collected by the enabled sensor.

4. The apparatus of claim 2, wherein the sound quality improving unit changes the transmission/reception sound quality by, in case where a motion for low pass is detected, changing an outputted low-frequency sound quality into a high-frequency sound quality by a filter value for the low pass and, in case where a motion for high pass is detected, changing an outputted high-frequency sound quality into a low-frequency sound quality by a filter value for the high pass.

5. The apparatus of claim 1, wherein a plurality of DSP filter values for controlling the voice quality are filter values whose gain values are differently controlled by frequency band.

6. The apparatus of claim 5, wherein the DSP filter value that controls the voice quality is mapped to a motion corresponding to each of the DSP filter values.

7. The apparatus of claim 1, wherein the sound quality improving unit changes a predefined DSP filter value using a predefined motion.

8. The apparatus of claim 7, wherein the sound quality improving unit uses one predefined DSP filter value, and changes the DSP filter value by changing a gain value corresponding to a frequency band of the DSP filter value depending on the motion.

9. A method for improving a voice quality in a portable terminal, the method comprising:
changing a Digital Signal Processing (DSP) filter value; and
controlling a voice quality according to a user's voice quality based on the changed DSP filter value.

10. The method of claim 9, wherein changing the DSP filter value further comprises:
detecting a user's motion;
determining a DSP filter value corresponding to the motion; and
changing a transmission/reception sound quality using the determined filter value.

11. The method of claim 10, wherein the detecting of the user's motion further comprises:
in case that it is determined that the portable terminal is busy, enabling a sensor capable of detecting a motion; and
determining a motion of the portable terminal using the detecting information collected by the enabled sensor.

12. The method of claim 10, wherein changing the transmission/reception sound quality further comprises:
in case where a motion for low pass is detected, changing an outputted low-frequency sound quality into a high-frequency sound quality by a filter value for the low pass; and
in case where a motion for high pass is detected, changing an outputted high-frequency sound quality into a low-frequency sound quality by a filter value for the high pass.

13. The method of claim 9, wherein a plurality of DSP filter values for controlling the voice quality are filter values whose gain value is differently controlled by frequency band.

14. The method of claim 13, wherein the DSP filter value that controls the voice quality is mapped to a motion corresponding to each of the respective DSP filter values.

15. The method of claim 9, wherein the changing of the DSP filter value further comprises: changing a predefined DSP filter value using a predefined motion.

16. The method of claim 15, wherein changing the DSP filter value uses one predefined DSP filter value, and changes a gain value corresponding to a frequency band of the DSP filter value depending on the motion.

17. A method for improving a voice quality in a mobile terminal by changing a predefined filter value, the method comprising:
determining if a user is on a voice call with another user;
determining a voice quality for the called user, if the user is on a voice call with another user;
determining if the voice quality is abnormal due to a high frequency band or a low frequency band;
determining if the voice quality is a high sound quality or a low sound quality;
performing a motion for a Low Pass Filter (LPF) operation if it is determined that the voice quality for the called user is a high sound quality;
performing a motion for a High Pass Filter (HPF) operation if it is determined that the voice quality for the called user is a low sound quality,
wherein the motion for the low pass or high pass filter operation comprises at least one of a preset motion and an easy motion of the mobile terminal directly set by the user, and
wherein the predefined filter comprises a filter whose gain value of the high frequency band or the low frequency band is differently set to pass the high frequency band or the low frequency band.

18. The method of claim 17, wherein the voice quality of the called user is continuously determined until the end of the call connection with the called user.

19. The method of claim 18, wherein the user of the mobile terminal sets a voice quality by a specific motion in a call connection state to improve the voice quality.
